(19) United States
(12) Patent Application Publication
(10) Pub. No.: US 2006/0277813 A1
(43) Pub. Date: Dec. 14, 2006

(54) Champagne bucket

(76) Inventor: Martin Saldana, Avalon, CA (US)

Correspondence Address: FULWIDER PATTON LEE & UTECHT, LLP, 200 OCEANGATE, SUITE 1550, LONG BEACH, CA, 90802, US

(21) Appl. No.: 11/148,462

(22) Filed: Jun. 9, 2005

(51) Int. Cl. A01K 97/10

(52) U.S. Cl. 43/21.2

(57) ABSTRACT

A mounting device including a beverage cooling bucket and a downwardly projecting stem configured for receipt in a fishing rod holder socket and constructed to hold such bucket erect for receipt of ice and cans of beverages to be cooled.

### BACKGROUND OF THE INVENTION

The present invention relates to a mounting device for mounting a beverage cooling bucket on a recreational fishing boat.

### Description of the Prior Art

Sports fishing is a popular recreational activity. This activity often involves outings in private or chartered fishing boats. The fishing party boats to a fishing area and participates in the fishing activity over a period of time at one or more locations before returning to shore. This activity can take place over a period of time extending from two or three hours to six or seven hours or even a couple of days.

Fishing is a popular sport in warm climates were the fishermen are often exposed to sun and heat. To maintain body fluid level, the fishermen typically consume beverages such as bottled water, sodas, juices and sometimes alcoholic beverages. There are frequently two, three, four or more crewman and fisherman working about the boat deck and each has his or her own personal can or bottle of beverage which may be sat down on seats, benches, tables or various shelving. These beverage containers, while unattended, can tip over, spill their contents and result in the partially emptied container rolling around the deck, table shelf or bench. Also, it is important to keep the beverages cool. While storage of the beverage containers in an ice cooler of the like is satisfactory for the transport to and from the fishing cite, during the fishing activity and recreational drinking thereafter, it is preferable to have ready and convenient access to the beverages from the cockpit as well as having a place where both unopened and opened containers can be conveniently stored within easy reach. To this end, it is desirable to have a cooling bucket which can be conveniently and removably mounted from readily available boat fixtures to position such bucket for easy access by passengers in the boat seating area or cockpit.

Many recreational fishing boats include one or more rod holders formed with upwardly opening sockets for receiving the butt end of a rod and which often times angle at 30° or so to the vertical. During the return trip from the fishing site, such rod holders are often not in use and, even at the fishing site are sometimes unoccupied. Consequently, such fishing rod holders offer an efficient expedient for mounting of various fishing or recreational devices. Such holders have in the past, been proposed for receipt of telescoping sleeves which mount a cup that receives a bottle in close fit relationship to hold the bottle erect. A holder of this type is shown in U.S. Pat. No. 4,749,162 to Wanzor. Such devices while acceptable for individual drinks and the like, are inadequate for holding heavy beverage buckets to be filled with ice and are relatively complicated and expensive to manufacture.

Consequently, there exists a need for an economical and sturdy mounting device to mounting a chilling bucket for quick and convenient attachment to and release from a rod holder socket.

### SUMMARY OF THE INVENTION

The bucket and mounting device of the present invention includes a large diameter, upright bucket for receiving multiple individual beverage containers and carried on a stem for slidable receipt in an upwardly opening rod socket projecting at a predetermined angle and formed on its top end with a horizontal plate which removably mounts a beverage chilling bucket.

The exact nature of the invention, as well as its obvious embodiments will become readily apparent to one of skill in the art upon reference to the following detailed description when considered in conjunction with the accompanying drawings, and which like reference numerals designate like parts throughout the figures thereof.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a respective view of a portion of a stern of a boat mounting a beverage chilling bucket device of the present invention;

FIG. 2 is a top plan view thereof;

FIG. 3 is a vertical sectional view, in enlarged scale, taken along the lines of 3-3 of FIG. 2;

FIG. 4 is a vertical sectional view taken along the lines of 4-4 of FIG. 1;

FIG. 5 is a sectional view taken along the line 5-5 in FIG. 4;

FIG. 6 is a vertical sectional view, in a large scale, taken along the lines of 6-6 of FIG. 5;

FIG. 7 is a horizontal sectional view taken along the lines of 7-7 of FIG. 6; and

FIG. 8 is a perspective view, in a large scale, of the bottom end of a stem included in the device show in FIG. 5.

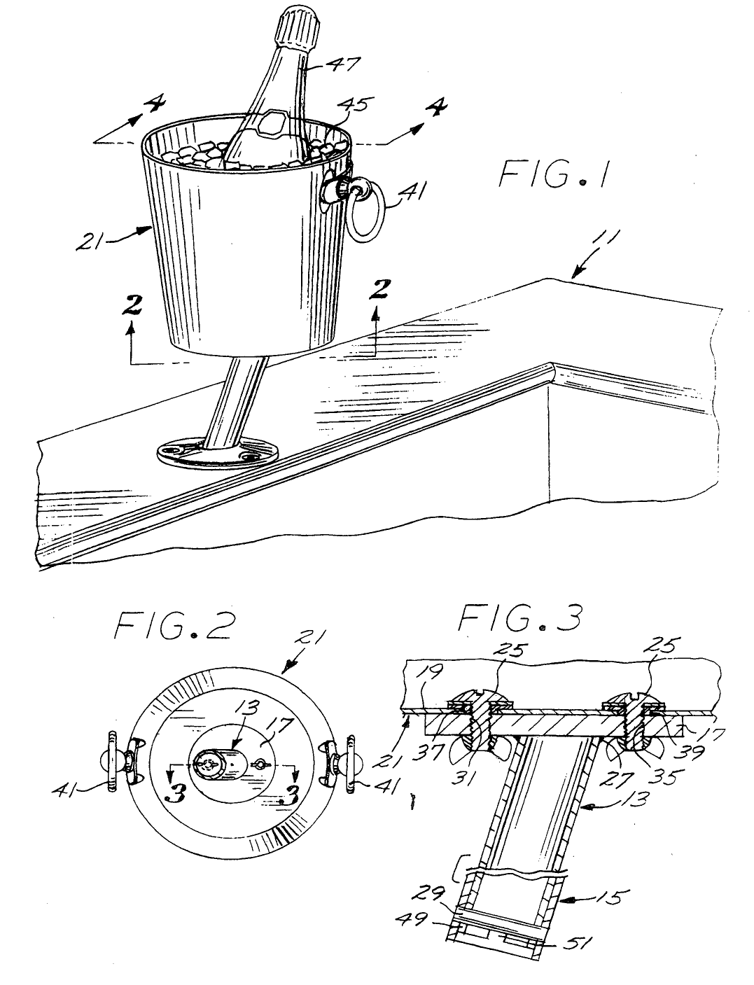

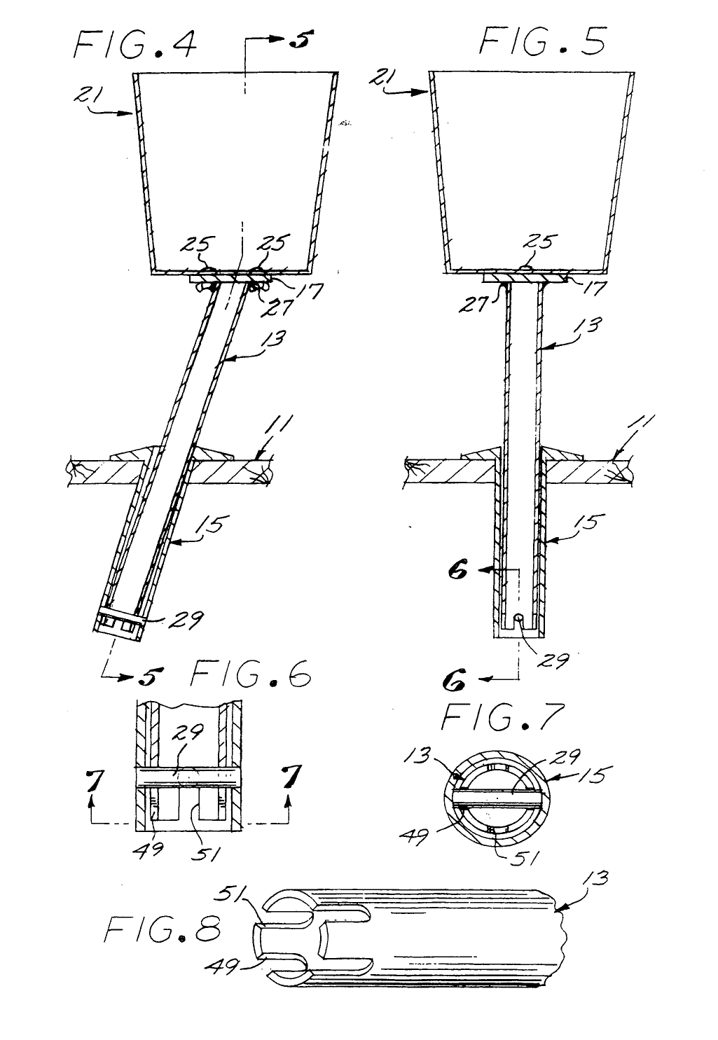

### DETAILED DESCRIPTION OF THE INVENTION

The following description is provided to enable any person of ordinary skill in the art to make and use the invention. It sets forth the best mode of carrying out the invention. The various modifications, however, will remain readily apparent to those skilled in the art, since the general principals of the invention have been defined herein specifically to provide a rod holder mounted device for carrying a beverage chilling bucket.

Referring to FIGS. 1 and 3, the rod holder mounted chilling bucket attachment device of the present invention includes, generally, a tubular stem 13 for telescopical receipt in an upwardly opening rod holder 15 angled at about 25° to 30° to the vertical and having mounted at its top end a horizontal mounting plate 17 to which the bottom wall 19 of a beverage chilling bucket 21 is affixed by means of wing nut screw bolts 25.

Those involved in recreational boat fishing are aware of a long standing problem with the storage and chilling of beverage containers in a manner which will keep open and unopened containers readily available and easily accessible from a local where the activity is taking place or where the crew is relaxing. It is important that the bucket device be readily attachable to existing fixtures such as rod holds and be held in position to offer the bucket top to crew and passenger personnel for ready retrieval of bottles or cans stored thereon. The device of the present of invention is directed to that problem.

The device of the present of invention may be made of any desired materials such as stainless steel, plastic, wood or the like. In the preferred embodiment, I construct my stem 13, plate 17 and bucket 21 of stainless steel and welded the stem and plate together by means of a weldment 27 (FIG. 3).

Fishing rod holder tubes 15 typically angle rearwardly in the craft at about 25° to 30° to the vertical. The plate 17 is thus mounted in a horizontal plane forming an acute angle of about 60° to 65° to the axis of the stem to maintain the cooling bucket 21 generally erect as shown in FIG. 1 to dispose the open top thereof in a generally horizontal plane for easy access for insertion and retraction of beverage cans and bottles. As will be apparent to those skilled in the art the bucket may be slightly tilted from the vertical, it only being important that it be positioned to contain ice, bottles, and cans for convenient access and storage.

Rod holder tubes typically incorporate an obstruction recessed downwardly therein for limiting the degree to which the butt of a fishing rod can be inserted therein to. In the example set forth therein, such obstruction is in a form of a cross pin 29 (FIGS. 5 & 6).

I have discovered that such obstructions are typically recessed about five inches down into the tubes such that, when the butt end of the 14½ inch long stem is engaged with the cross pin 99, the bucket 21 will be elevated about 8″ to 9½ inches above the top of the tube thus spacing it nicely above the gunnel or railing and positioning the open top of the bucket for easy access by passengers and crew milling about the cockpit or sitting on benches adjacent the rail.

I have selected my stem 13 with a length of about 14½ inches taking into consideration the inside diameter of typical holder tubes, to form a lose fit telescopical relationship therewith I selected my stem with an outside diameter of 1½″ inches.

The base plate 17 is about 4 inches in diameter and about ⅛ inch thick. Such plate is formed with a pair of bores 31 and 35 located on a diameter of such plate and spaced apart on opposite sides of the center thereof.

The bottom wall of the bucket 21 is formed with bores 37 and 39 spread apart for alignment with the bores 31 and 35 in the plate and sized for receipt of the shanks of stainless steel stone bolts receiving wing nut 25.

The bucket 21 itself is about 9 inches in diameter on the top and about 9¼ inches deep. It typically incorporates holding rings 41 mounted on the opposite sides thereof for lifting.

The wall of the stem 13 is formed at the bottom extremity with two pair of diametrical slots 49 and 51 (FIG. 8) disposed on diameters oriented perpendicular to one another to thus facilitate rotary registration of such stem in the fishing rod holder to prevent rotation thereof and consequent disorientation of the bucket 21 from the vertical.

It will be appreciated that the bucket holder of the fishing rod holder bucket mounting device of the present invention may take numerous different forms and that the plate 17 may be mounted at various selected angles relative to the stem so as to maintain the desired upright position of the bucket depending on the particular angel of the rod holder tube 15.

In operation, it will be appreciated that when the boat 11 is loaded and the crew on board, ice 45 and beverages 47 will be stowed in an ice chest, cooler or the like until access is to be had thereto. The bucket 21 will be disassembled from the pad 17 and stowed for convenient retrieval.

When beverage cans or bottles are to be cooled and served, the stem 13 and bucket 21 may be retrieved and assembled. The bolts 25 will be inserted through the respective bores 37 and 39 in the bottom of the bucket and through the corresponding bores 31 and 35 in the plate 17 and the wing nuts 27 applied. The stem 13 may then be conveniently telescoped downwardly into the holder 15 and such stem rotated about its axis within the holder to orient the bucket 21 in its upright position and align the corresponding pair of registration slots 49 or 51 with the cross pin 29 and engage them to thereby maintain the desired registration and support the stem projected above the boat railing to elevate the bucket upright as shown in FIG. 1. The bucket 21 may then be filled ice 45 and the beverage container(s) 47 placed therein. While only a single beverage container 47 is shown it will be appreciated that the apparatus of the present invention has great utility in providing a storage and presentation bucket which might contain 5 to 7 or even more 12-ounce cans or bottles for ready removal and return by personnel in and about the cockpit. This serves to invite experienced and novice fishermen alike to help themselves as desired and to return the beverage containers to the bucket for storage until the drink is fully consumed.

When the fishing trip is completed, the stem 13 may be easily withdrawn from the holder tube 15, the left over beverages removed from the bucket 21 and such bucket inverted to discard any residual ice 45. The wing nuts bolts 27 may then be removed from the bolts 25 and the bucket 21 disassociated from the plate 17 for convenience storage.

From the foregoing it will be appreciated that the fishing rod holder mounted chilling bucket support device of the present invention is inexpensive to manufacture and provides a durable and convenient means for supporting beverages in a chilling condition for ready access on a fishing vessel.

While a particular form of the invention has been illustrated and described, it will also be apparent to those skilled in the art that various modifications can be made without departing from the spirit and scope of the invention. Accordingly, it is not intended that the invention be limited except by the appended claims.

I claim:

1. Beverage chilling bucket mounting device for mounting a beverage container-receiving bucket in an erect position from an upwardly opening socket of a fishing rod holder tube angling at a predetermined angle to the vertical and comprising:
an elongated stem sized to be slidable received in such socket to angle at such predetermined angel and terminating in a top end;
a support plate mounted on such top end and formed with an upwardly facing support surface to support the bottom side of such bucket; and
a releasable fastener device for fastening such bucket to such plate whereby the bucket may be positioned on the plate and fastened thereto by the fastener and the stem slidably inserted into the socket to cause it to hold the bucket erect for receipt of ice and beverage containers to be cooled.

2. Beverage chilling bucket mounting device is set forth in claim 1 wherein;
the plate is mounted in a plane forming an angle of substantially 60° to the longitudinal axis of the stem.

3. Beverage chilling bucket mounting device is set forth in claim 1 wherein;
the plate is formed with mounting bores; and
the releasable fasteners include bolts.

4. Beverage chilling bucket mounting device is set forth in claim 1 wherein;
the releasable fastener includes wing nut bolts.

5. Beverage chilling bucket mounting device is set forth in claim 1 for use with a fishing rod holder tube having a cross pin mounted to project across such socket and wherein:
the stem is formed with downwardly opening slots configured to be slidably received over such cross pen for registration therewith to limit rotation of such rod relative to such holder.

6. The Beverage chilling bucket mounting device of claim 5 wherein;
the stem includes a plurality of downwardly opening registration slots arranged on respective transverse axis projecting perpendicular to one another.

7. The Beverage chilling bucket mounting device set forth in claim 1 that includes:
a cylindrical chilling bucket having a diameter of substantially 9 inches.

8. A beverage chilling bucket mounting device to be mounted from an upwardly opening socket of a fishing rod holder angling at substantially 30° to the vertical and including a recessed cross pin, the device comprising:
an elongated tubular stainless steel stem sized to be slidably received in the socket and configured on its lower extremity with a transversely projecting slot configured to be slidably received over the pin to, when the slot is received over the pin, limit rotation of such stem within the socket hold the stem in a predetermined orientation;
a stainless steel support plate on the top end of such stem and configured with an upwardly facing support surface in a plane angled at substantially 30° to the axis of the stem and configured to be, when the stem is received in the socket and the slot received over the pin, disposed in a horizontal and configured with a pair of laterally spaced apart through bores;
an upwardly opening chilling bucket substantially 9 inches in diameter and including a bottom wall disposed on the support surface and formed with a pair of through bores configured to mate with the bores in the mounting plate; and
fastener bolts assemblies for receipt in the respective such bores for releasably mounting the bucket on the mounting plate whereby the bucket may be positioned on the support surface and the bolt devices inserted in the bores to hold the bucket on the plate and the stem inserted in the socket to register the slot to be slidably received over the pin to hold the bucket in a substantially erect position for receipt of a plurality of beverage containers.
